(19) United States
(12) Patent Application Publication
(10) Pub. No.: US 2016/0171583 A1
(43) Pub. Date: Jun. 16, 2016

(54) SYSTEMS AND METHODS FOR DETERMINING CHILD CLOTHING SIZE

(71) Applicant: eBay Inc., San Jose, CA (US)

(72) Inventors: Dane Glasgow, Los Altos, CA (US); Corinne Elizabeth Sherman, San Jose, CA (US); Matthew Bret MacLaurin, Santa Cruz, CA (US); David Ramadge, San Jose, CA (US); Bria Selhorst, Albany, CA (US); Timothy Carlson, Menlo Park, CA (US)

(21) Appl. No.: 14/568,251

(22) Filed: Dec. 12, 2014

(51) Int. Cl. G06Q 30/06; G06T 7/60; G06Q 50/00; G06K 9/62; G06F 17/30; G06K 9/00; G06K 9/52

(52) U.S. Cl. CPC G06Q 30/0625; G06K 9/00369; G06T 7/602; G06K 9/52; G06K 9/6201; G06F 17/30265; G06Q 50/01; G06T 2207/30196

(57) ABSTRACT

Aspects of the present disclosure include a system comprising a computer-readable storage medium storing at least one program and a computer-implemented method for determining a clothing size of a child. Consistent with some embodiments, the method may include obtaining at least one image of the child, and deriving one or more previous body measurements from the at least one image. The method further includes determining one or more current body measurements of the child based on the previous body measurements, and using the one or more current body measurements to determine the clothing size of the child.

### TECHNICAL FIELD

This application relates to data processing. In particular, example embodiments may relate to systems and methods for determining child clothing size.

### BACKGROUND

Children's clothing sizes are traditionally expressed in age ranges. For example, infant clothing sizes come in the following sizes: 0-3 months; 3-6 months; 6-9 months; 12 months; 18 months; and 24 months. This traditional sizing paradigm assumes that children of similar ages are also similarly sized; however, children vary widely in shape and size regardless of age. As such, these sizes do not often track the actual size of many children. This discrepancy makes purchasing gifts for children difficult, as the gift giver does not know whether clothing will actually fit the child even though the child may be within the age range denoted by the size. This is particularly a problem in climates that have multiple seasons because by the time the child fits in the clothes, it may be too cold or too hot to wear them.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a network system having a client-server architecture configured for exchanging data over a network with a content publisher, according to example embodiments.

FIG. 2 is a block diagram depicting various functional components of a child clothing size application, which is provided as part of the network system, according to example embodiments.

FIG. 3 is a flow chart illustrating a method for determining a clothing size of a child, according to example embodiments.

FIG. 4 is a flow chart illustrating a method for obtaining previous body measurements of a child, according to an example embodiment.

FIGS. 5A and 5B are interaction diagrams depicting example exchanges between a client device, an application server, and a third party server, according to example embodiments.

FIG. 6 is a flow chart illustrating a method for determining current body measurements of a child, according to example embodiments.

FIG. 7 is a chart illustrating expected growth data, according to an example embodiment.

FIG. 8 is a flow chart illustrating a method for identifying a child clothing size using a clothing size table, according to example embodiments.

FIG. 9 illustrates a table including clothing size data, according to an example embodiment.

FIG. 10 is a block diagram illustrating various functional components of a marketplace application, which is provided by the networked system, according to example embodiments.

FIG. 11 is a flow chart illustrating a method for providing child clothing recommendations, according to example embodiments.

FIG. 12 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

Aspects of the present disclosure involve systems and methods for determining clothing sizes of children. Although the terms “children” and “child” are used extensively throughout this disclosure, these terms are not intended to limit the scope of the inventive subject matter to a specific age range as these terms may be used herein to encompass newborns, infants, toddlers, adolescents, and the like. Further, the systems and methods described herein may find equally suitable application in determining clothing sizes of adults.

Example embodiments of such methods may include obtaining images (e.g., pictures or video) of a child and acquiring previous body measurements of the child from the obtained images. The previous body measurements may then be used by the system to derive current body measurements of the child using expected growth data (e.g., a growth chart). The body measurements—both “previous” and “current”—may, for example, include a height (or recumbent length), a weight, a head circumference, a waist size, a chest size, other measurements of body girth (e.g., a circumference of an arbitrary line encircling a portion of the child's body), or any other such measurements that may be used to specify body proportions for the purpose of fitting clothes.

Consistent with some embodiments, the methods may use the current body measurements in conjunction with clothing size data (e.g., a clothing size chart) to determine a clothing size for the child. The method may further include causing the clothing size of the child to be presented to a user (e.g., displayed on a device being operated by the user). Accordingly, aspects of the present disclosure may provide users with a quick and reliable means for determining the clothing size of a child. Further, in some embodiments, the determined clothing size of the child may be used to provide one or more recommendations for children's clothing that is available in the appropriate size for the child. In this manner, potential gift givers such as friends and family are enabled to purchase appropriately sized gifts for children without knowing the current size of the child.

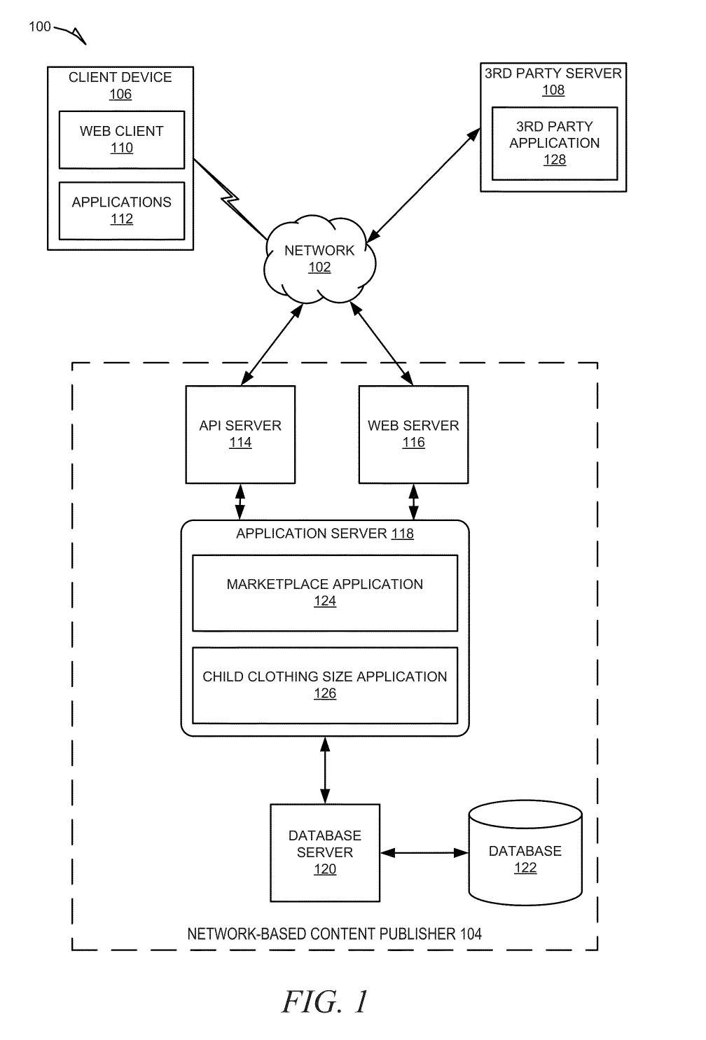

FIG. 1 is a network diagram depicting a network system 100, according to one embodiment, having a client-server architecture configured for exchanging data over a network 102. While the network system 100 is depicted as having a client-server architecture, the present inventive subject matter is, of course, not limited to such an architecture, and could equally well find application in an event-driven, distributed, or peer-to-peer architecture system, for example. Further, to avoid obscuring the inventive subject matter with unnecessary detail, various functional components that are not germane to conveying an understanding of the inventive subject matter have been omitted from FIG. 1. Moreover, it shall be appreciated that although the various functional components of the network system 100 are discussed in a singular sense, multiple instances of any one of the various functional components may be employed.

The network system 100 includes a network-based content publisher 104 in communication with a client device 106 and a third party server 108. In some example embodiments, the network-based content publisher 104 may be a network-based marketplace (e.g., eBay.com). The network-based content publisher 104 communicates and exchanges data within the network system 100 that may pertain to various functions and aspects associated with the network system 100 and its users. The network-based content publisher 104 may provide server-side functionality, via a network 102 (e.g., the Internet), to network devices such as the client device 106.

The client device 106 may be operated by users who use the network system 100 to exchange data over the network 102. These data exchanges may include transmitting, receiving (communicating), and processing data to, from, and regarding content and users of the network system 100. The data may include, but are not limited to, images; video or audio content; user preferences; product and service feedback, advice, and reviews; product, service, manufacturer, and vendor recommendations and identifiers; product and service listings associated with buyers and sellers; product and service advertisements; auction bids; transaction data; user profile data; expected growth data; clothing size data; and social data, among other things.

The client device 106 interfaces with the network-based content publisher 104 via a connection with the network 102. Depending on the form of the client device 106, any of a variety of types of connections and networks 102 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the network 102 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or other types of networks).

In another example, the connection to the network 102 may be a Wireless Fidelity (Wi-Fi, IEEE 802.11x type) connection, a Worldwide Interoperability for Microwave Access (WiMAX) connection, or another type of wireless data connection. In such an embodiment, the network 102 may include one or more wireless access points coupled to a local area network (LAN), a wide area network (WAN), the Internet, or another packet-switched data network. In yet another example, the connection to the network 102 may be a wired connection (e.g., an Ethernet link), and the network 102 may be a LAN, a WAN, the Internet, or another packet-switched data network. Accordingly, a variety of different configurations are expressly contemplated.

In various embodiments, the data exchanged within the network system 100 may be dependent upon user-selected functions available through one or more client or user interfaces (UIs). The UIs may be associated with a web client 110 (e.g., an Internet browser) operating on the client device 106, which may be in communication with the network-based content publisher 104. The UIs may also be associated with one or more applications 112 executing on the client device 106, such as a mobile application designed for interacting with the network-based content publisher 104 or with a social network platform hosted by the third party server 108.

Turning specifically to the network-based content publisher 104, an API server 114 and a web server 116 are coupled to, and provide programmatic and web interfaces respectively to, an application server 118. As illustrated in FIG. 1, the application server 118 is coupled via the API server 114 and the web server 116 to the network 102, for example, via wired or wireless interfaces. The application server 118 is, in turn, shown to be coupled to a database server 120 that facilitates access to a database 122. In some examples, the application server 118 can access the database 122 directly without the need for the database server 120. The database 122 may include multiple databases that may be internal or external to the network-based content publisher 104.

The application server 118 may, for example, host one or more applications, which may provide a number of content publishing and viewing functions and services to users who access the network-based content publisher 104. For example, the network-based content publisher 104 may host a marketplace application 124 that provides a number of marketplace functions and services to users, such as publishing, listing, and price-setting mechanisms whereby a seller may list (or publish information concerning) goods or services (also collectively referred to as “products”) for sale, a buyer can express interest in or indicate a desire to purchase such goods or services, and a price can be set for a transaction pertaining to the goods or services.

As illustrated in FIG. 1, the application server 118 also hosts a child clothing size application 126 that may be utilized by users of the network system 100 to obtain determinations of clothing sizes of children. For example, a user may use the client device 106 to communicate a request for a child's clothing size to the application server 118. The child clothing size application 126, in turn, analyzes one or more images of the child in conjunction with expected growth data and clothing size data to determine the clothing size of the child, which may then be presented to the user on the display of the client device 106.

The database 122 may be used to store data pertaining to various functions and aspects associated with the network system 100 and its users. For example, the database 122 may store and maintain user profiles for users of the network-based content publisher 104. Each user profile may comprise user profile data that describes aspects of a particular user. The user profile data may, for example, include demographic data, user preferences, social data, and financial information. The demographic data may, for example, include information describing one or more characteristics of a user such as gender, age, location information (e.g., hometown or current location), employment history, education history, contact information, familial relations, or user interests. The financial information may, for example, include private financial information of the user such as account number, credential, password, device identifier, user name, phone number, credit card information, bank information, transaction history, or other financial information which may be used to facilitate online transactions by the user.

In instances in which the network-based content publisher 104 is a network-based marketplace, the database 122 may store product information. Such product information may, for example, include a product identifier (e.g., a title or a model number), a price, a make, a manufacturer, a model, a brand name, a textual description, a size, a style, product dimensions, compatibility information, or any other information that may be used to describe a product.

FIG. 1 also illustrates a third party application 128 executing on the third party server 108 that may offer information or services to the application server 118 or to users of the client device 106. The third party application 128 may have programmatic access to the network-based content publisher 104 via a programmatic interface provided by the API server 114. The third party application 128 may be associated with any organization that conducts transactions with or provide services to the application server 118 or to users of the client device 106. For example, the third party application 128 may be associated with a network based social network platform (e.g., Facebook®, Twitter®, Google+®, Pinterest®, LinkedIn®, or the like) that may provide a platform for members to build and maintain social networks and relations among members.

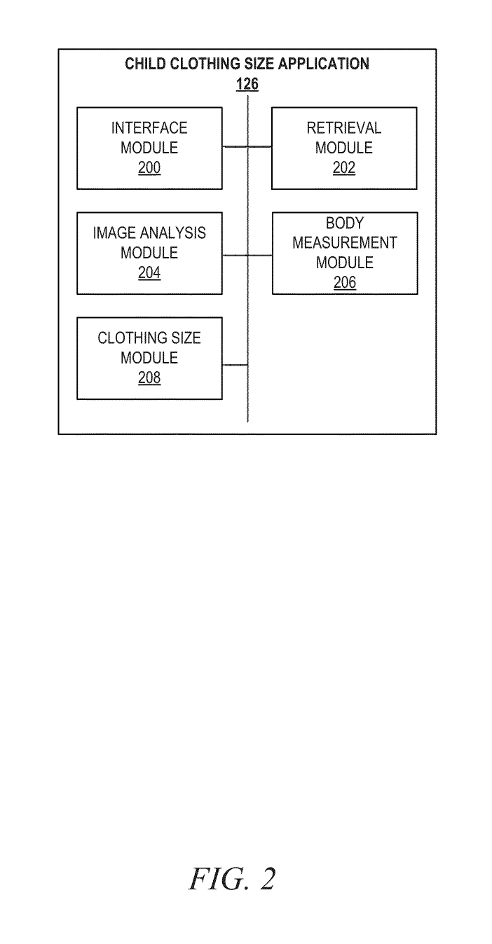

FIG. 2 is a block diagram depicting various functional components of a child clothing size application 126, which is provided as part of the network system 100, according to example embodiments. As is understood by skilled artisans in the relevant computer and Internet-related arts, each component (e.g., a module or engine) illustrated in FIG. 2 may represent a set of logic (e.g., executable software instructions) and the corresponding hardware (e.g., memory and processor) for executing the set of logic. Further, each component illustrated in FIG. 2 may be hosted on dedicated or shared server machines that are communicatively coupled to enable communications between server machines.

The child clothing size application 126 is illustrated in FIG. 2 as including an interface module 200, a retrieval module 202, an image analysis module 204, a body measurement module 206, and a clothing size module 208, all configured to communicate with each other (e.g., via a bus, shared memory, a switch, or application programming interfaces (APIs)). Each of the various components of the child clothing size application 126 may access one or more network databases, and each of the various components of the child clothing size application 126 may be in communication with one or more of the third party applications. Further, while the components depicted in FIG. 2 are discussed in the singular sense, it will be appreciated that in other embodiments multiple instances of any one of these components may be employed.

The interface module 200 is responsible for generating and displaying various graphical user interfaces (GUIs) for presenting information related to the functionalities discussed herein. For example, the interface module 200 may generate a GUI for presenting the clothing size of a child, and may provide instructions to the client device 106 to cause the client device 106 to display the GUI. The interface module 200 is also responsible for receiving requests for determining a child's clothing size. In some embodiments, the requests may be received via one or more GUIs generated by the interface module 200. In other embodiments, the interface module 200 may work in conjunction with the API server 114 to receive client requests from the application 112 executing on the client device 106 or from the third party application 128 executing on the third party server 108.

The retrieval module 202 is configured to retrieve data related to the various functionality discussed herein. For example, the retrieval module 202 may retrieve social data associated with one or more social network profiles from which information about a child (e.g., images or temporal attributes) may be extracted. The retrieval module 202 may further be configured to retrieve images of a child from user designated sources such as local storage of the client device 106, a memory component of a camera communicatively coupled to the client device 106, a networked repository or file hosting service (e.g., Dropbox®), or a third party network based content publisher (e.g., Tumblr®).

The image analysis module 204 is configured to process and analyze images (e.g., picture files or video files) and other image data (e.g., .GIF files) in order to produce information used by the methodologies discussed herein. The image analysis module 204 may employ any one of several known image analysis and object recognition techniques (e.g., edge detection, edge matching, greyscale matching, gradient matching, or pattern recognition) to derive body measurements of a child at the time of an image (e.g., previous body measurements). For example, the image analysis module 204 may identify a reference object of known dimensions that is visible in an image of a child, and use the known dimensions of the reference object as a scaling factor to determine one or more body measurements of the child. The reference object may be any object of known or standard dimensions such as a credit card, a coin or other currency, a compact disc, a soda can, or other such objects. The image analysis module 204 may be further configured to extract temporal attributes from image data such as a timestamp maintained as metadata of a particular image.

The body measurement module 206 is configured to determine current body measurements of a child based on previous body measurements of the child. The body measurement module 206 may determine the current body measurement of the child based on expected growth data stored in the database 122 or accessed from one or more third party servers 108. The expected growth data comprises a series of expected body measurements of children over time, and may include expected body measurements for children of a variety of different initial body sizes and shapes. The expected growth data may, for example, include expected body measurements for a recumbent length (e.g., the height of the child measured while lying down), a weight, a waist size, a chest size, a body girth, and a head circumference. The expected growth data may be developed based on observations or surveys of the growth of a plurality of children over time, and in some embodiments, may be extracted from one or more growth charts such as those produced routinely by the World Health Organization (WHO).

The clothing size module 208 is configured to determine a clothing size of a child. The clothing size module 208 may determine the clothing size of the child based on the current body measurements determined by the body measurement module 206. Consistent with some embodiments, the clothing size module 208 may identify the clothing size of the child based on clothing size data stored in the database 122 or accessed from one or more third party servers 108. The clothing size data comprises information regarding the body measurements to which a particular clothing size is intended to correspond. In some embodiments, the clothing size data may be dependent upon a particular brand or clothing manufacturer. The clothing size data may further vary based on the country in which the clothing is made or sold.

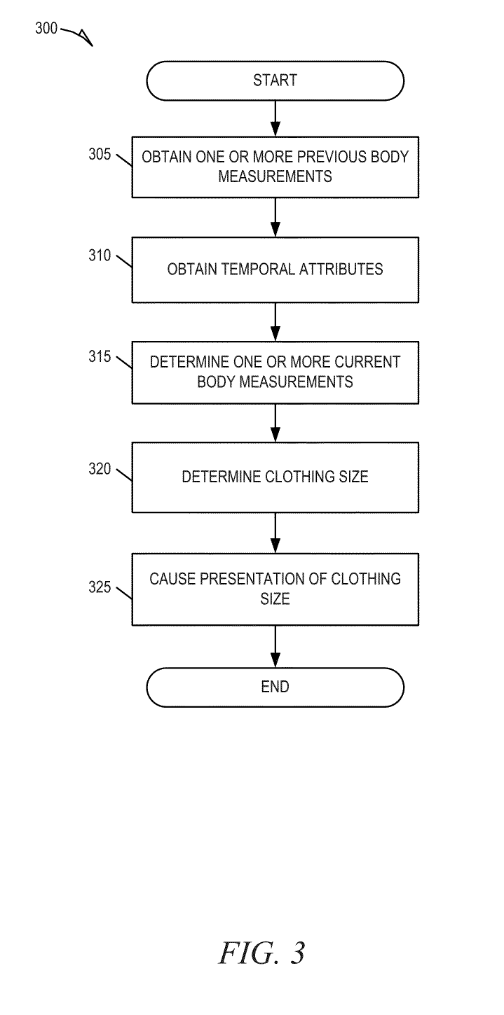

FIG. 3 is a flow chart illustrating a method 300 for determining a clothing size of a child, according to example embodiments. The method 300 may be embodied in computer-readable instructions for execution by one or more processors such that the steps of the method 300 may be performed in part or in whole by the application server 118. In particular, the method 300 may be carried out by the functional components of the child clothing size application 126, and accordingly, the method 300 is described below by way of example with reference thereto. However, it shall be appreciated that the method 300 may be deployed on various other hardware configurations such as the client device 106 and is not intended to be limited to the functional components of the child clothing size application 126.

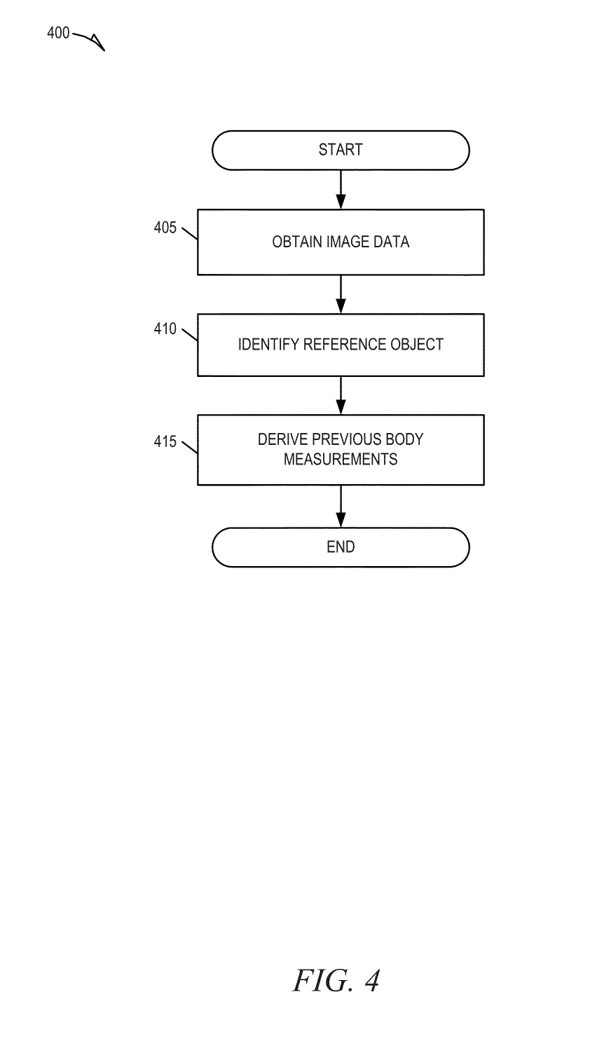

The method 300 may be initiated or triggered by a client request (e.g., received from the client device 106) to determine the current clothing size of a child. At operation 305, the body measurement module 206 obtains one or more previous body measurements of a child. The body measurements may, for example, include at least one a height (or recumbent length), a weight, a head circumference, a waist size, a chest size, other measurements of body girth (e.g., a circumference of an arbitrary line encircling a portion of the child's body) or any other such measurements that may be used to specify body proportions for the purpose of fitting clothes. In some embodiments, the one or more previous body measurements may be received by the interface module 200 as user input while in other embodiments, the one or more previous body measurements may be derived by the image analysis module 204 from an image of the child. Further details of the operation 305 according to example embodiments are presented below in reference to FIG. 4.

At operation 310, the body measurement module 206 obtains temporal attributes related to the age of the child. The temporal attributes may, for example, include a birth date of the child, a date corresponding to the previous body measurements, a current age of the child, or an age of the child corresponding to the previous body measurements. In some embodiments, temporal attributes may be received by the interface module 200 as user input while in other embodiments, the temporal attributes may be derived by the image analysis module 204 from an image of the child or extracted from social data retrieved by the retrieval module 202.

At operation 315, the body measurement module 206 determines one or more current body measurements of the child. For example, the body measurement module 206 may utilize expected growth data (e.g., a growth chart) to estimate the one or more current body measurements of the child based on the one or more previous body measurements, the current age of the child, and the age of the child corresponding to the one or more previous body measurements. In instances in which the temporal attributes obtained at operation 310 do not include the current age of the child or the age of the child corresponding to the one or more previous body measurements, the body measurement module 206 may use the temporal attributes to determine either one of the current age of the child or the age of the child corresponding to the one or more previous body measurements prior to determining the one or more current body measurements of the child.

At operation 320, the clothing size module 208 determines a current clothing size of the child using the one or more current body measurements of the child. For example, the clothing size module 208 may access a clothing size table, and compare the one or more current body measurements to the information in the clothing size table to identify the current clothing size of the child.

At operation 325, the interface module 200 causes presentation of the current clothing size of the child on the client device 106. For example, the interface module 200 may provide the client device 106 with a set of computer readable instructions that cause the client device 106 to display one or more GUIs that include a presentation of the current clothing size of the child. Such GUIs may further include a presentation of the one or more previous body measurements and the one or more current body measurements.

FIG. 4 is a flow chart illustrating a method 400 for obtaining previous body measurements of a child, according to an example embodiment. In some embodiments, the method 400 may correspond to the operation 305. The method 400 may be embodied in computer-readable instructions for execution by one or more processors such that the steps of the method 400 may be performed in part or in whole by the application server 118. In particular, the method 400 may be carried out by the functional components of the child clothing size application 126, and accordingly, the method 400 is described below by way of example with reference thereto. However, it shall be appreciated that the method 400 may be deployed on various other hardware configurations, such as the client device 106, and is not intended to be limited to the functional components of the child clothing size application 126.

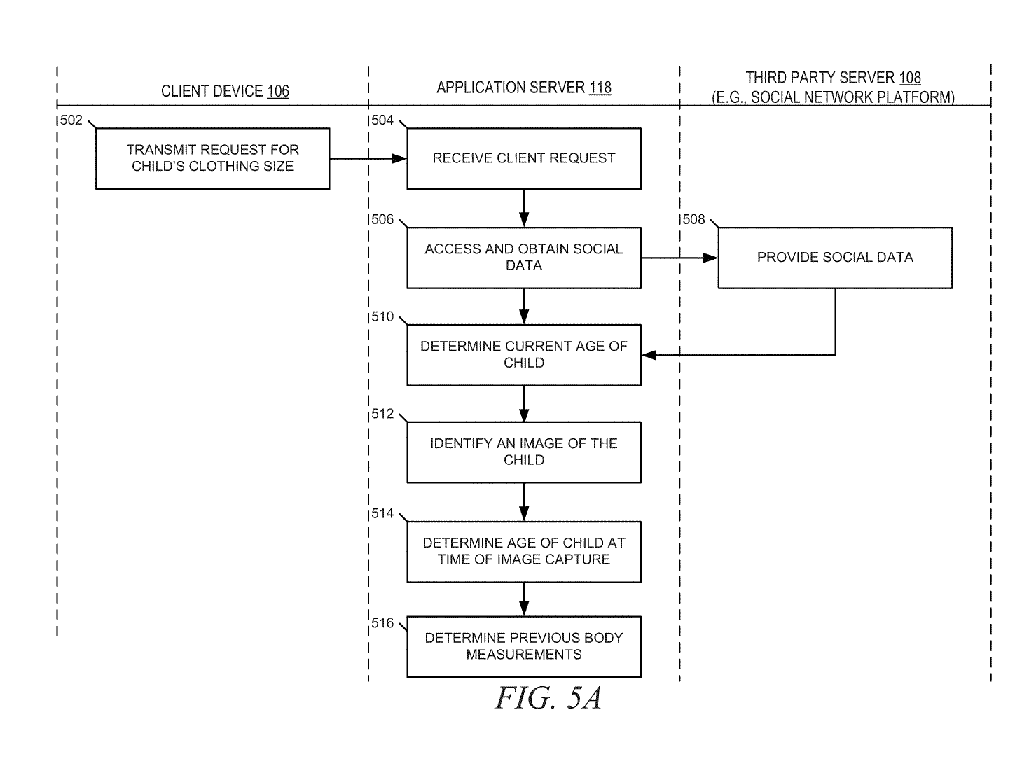

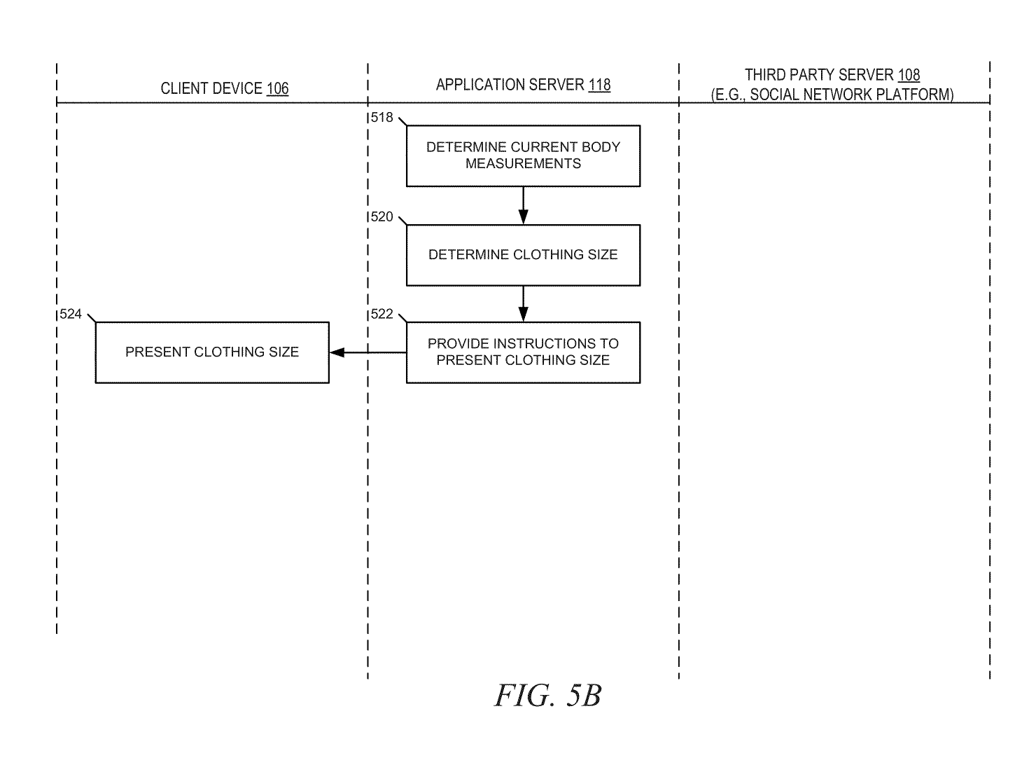

At operation 405, the retrieval module 202 obtains image data (e.g., a picture or a video) including an image depicting a child at a particular age (e.g., a younger age than the current age of the child). In some instances, the image data may be received from a user by a user interface provided by the interface module 200. In some instances, the image data may be retrieved from a third party website that hosts images. In some instances, the image data may be extracted from social data corresponding to a social network profile of the child. For example, the image data may be obtained from social data corresponding to a social network profile of a parent of the child. Further details of such embodiments are discussed below in reference to FIG. 5.

At operation 410, the image analysis module 204 identifies a reference object that is visible in the image of the child. The image analysis module 204 may identify the reference object by performing one or more known image analysis and object recognition techniques. The reference object is an object with known or standard dimensions such as a soda can, a credit card, or a coin.

At operation 415, the image analysis module 204 derives one or more previous body measurements of the child in the image based on the known dimensions of the reference object. In essence, the reference object serves to provide a scaling factor that may be used by the image analysis module 204 to calculate various dimensions of the child, which form the one or more previous body measurements. The body measurements are considered “previous” body measurements in the sense that they are the body measurements of the child as of the time of the image as opposed to the current body measurements of the child.

In some instances, the previous body measurements derived by the image analysis module 204 may depend on a number of known dimensions of the reference object. For example, assuming that two dimensions—length and width—of the reference object are known, the image analysis module 204 may derive the length and width of the child, but not the depth of the child. If, however, three dimensions of the reference object—length, width, and depth—are known, the image analysis module 204 may derive the length, width, and depth of the child.

FIGS. 5A and 5B are interaction diagrams depicting example exchanges between a client device, an application server, and a third party server, according to example embodiments. In particular, FIGS. 5A and 5B depict example exchanges between the client device 106, the application server 118, and the third party server 108, which, in this example embodiment, corresponds to a social network platform.

As shown, the process begins at operation 502 where the client device 106 (the user of which may be referred to as the “requesting user” or “requestor”) transmits a request for a determination of a child's clothing size to the application server 118. The request may be triggered in response to user input received from a GUI displayed on the client device 106. The GUI may be presented by an application 112 executing on the client device 106. The request may, for example, include any one of an identifier of the child (e.g., a name), one or more images of the child, temporal attributes (e.g., a birth date, a current age, a date of capturing the one or more images, or an age of the child at the time of capturing the one or more images), or an identifier of a social network profile from which information about the child (e.g., one or more images, temporal attributes) may be extracted and gathered (e.g., a parent's social network profile). In the example embodiment illustrated in FIG. 5, the request includes at least an identifier of a social network profile of one of the child's parents.

At operation 504, the application server 118 receives the client request, and at operation 506, the application server 118 obtains social data corresponding to the social network profile identified in the client request. The social data may, for example, be obtained by transmitting a request (e.g., via API) to the third party server 108 hosting a social network platform to which the social network profile belongs. The third party server 108, in turn, provides the social data to the application server 118, at operation 508.

The term “social data” as used herein refers to information maintained by a social network platform about its members. The social data of each member may contain information such as demographic information (e.g., gender, age, relationship status, employment status and history, household size), geographic information (e.g., a hometown, a current location, locations visited), interests and affinities (e.g., items the member “liked”), a list of social network connections, and a history of social network activity of the user. For purposes of the present disclosure, a social network “connection,” also referred to as being “connected” on a social network, may include situations in which there is a reciprocal agreement between members of the social network to be linked on the social network, as well as situations in which there is only a singular acknowledgement of the “connection” without further action being taken by the other member. In the reciprocal agreement situation, both members of the “connection” acknowledge the establishment of the connection (e.g., friends). Similarly, in the singular acknowledgement situation, a member may elect to “follow” or “watch” another member. In contrast to the reciprocal agreement, the concept of “following” another member typically is a unilateral operation because it may not call for acknowledgement or approval by the member who is being followed.

For purposes of the present disclosure, “social network activity” collectively refers to user interactions (e.g., creating, sharing, viewing, commenting, providing feedback, or expressing interest) with entries (e.g., text and image posts, links, messages, notes, invitations). Such social network activity may involve entries that are intended for the public at large as well as entries intended for a particular social network connection or group of social network connections. Depending on the social network platform, the social network activity may be published in an entry and may involve entries such as an activity feed post, a wall post, a status update, a tweet, a pinup, a like, a content share (e.g., content shared from a source such as the network-based content publisher 104), or a check-in.

At operation 510, the application server 118 analyzes the social data to determine a current age of the child. For example, the application server 118 may identify social network activity from the social data that pertains to the birth of the child, and as such, may include a reference to the birth date of the child. The application server 118 may then use the current date to determine the current age of the child. It shall be appreciated that in some instances, the current age of the child may be included in the client request received at operation 504, and in such instances, the application server 118 need not extract the current age of the child from the social data.

At operation 512, the application server 118 identifies an image of the child from the social data. For example, the application server 118 may use a name of the child provided in the client request to identify entries from the social data that include a reference to the name of the child in conjunction with an image. In some instances, the client request may include a reference (e.g., a URL) to a particular image associated with an identified social network profile, and in these instances, the application server 118 may simply access the referenced image.

At operation 514, the application server 118 determines an age of the child at the time the identified image was captured. For example, the application server 118 may analyze the social data to identify a posting date of a social network entry including the image. The posting date is used in conjunction with the current age of the child (identified at operation 510) to determine the age of the child at the time the identified image was captured. In another example, the application server 118 may access a timestamp included in metadata of the image (e.g., forming part of the image data discussed in reference to operation 405 of FIG. 4) to identify the date the image was captured, which may be used in conjunction with the current age of the child to determine the age of the child at the time the identified image was captured.

At operation 516, the application server 118 determines one or more previous body measurements (e.g., a length, girth, or head circumference) of the child using the image of the child. For example, the application server 118 identifies a reference object in the image, and uses the known dimensions of the reference object to derive the one or more previous body measurements of the child.

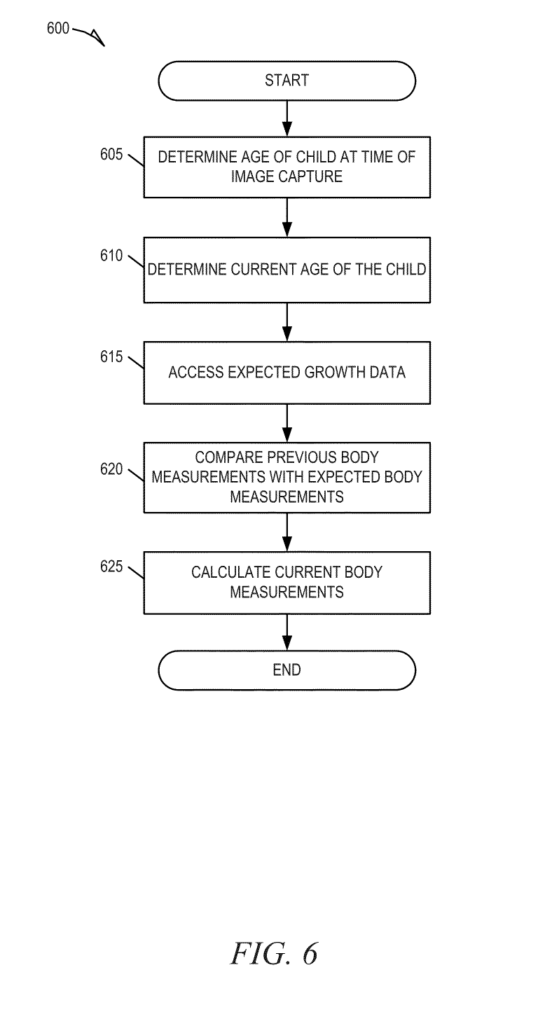

Turning to FIG. 5B, at operation 518, the application server 118 determines one or more current body measurements of the child based on the one or more previous body measurements. For example, the application server 118 may compare the one or more previous body measurements to expected growth data that includes a series of expected body measurements for children of various ages and of various initial body measurements. The application server 118 may use the one or more previous body measurements to extrapolate the one or more current body measurements from the expected growth data. Further details regarding the determination of current body measurements of a child, according to an example embodiment, are discussed below in reference to FIG. 6.

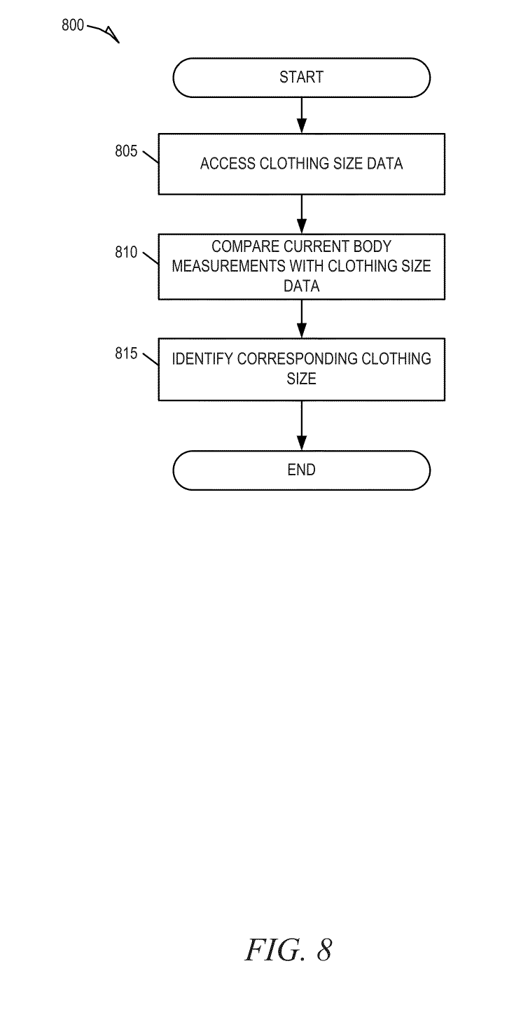

At operation 520, the application server 118 determines a clothing size of the child based on the one or more current body measurements. For example, the application server 118 accesses a clothing size chart or other such information to identify the clothing size of the child using the one or more current body measurements of the child. Further details regarding the determination of clothing size of a child, according to an example embodiment, are discussed below in reference to FIG. 8.

At operation 522, the application server 118 provides a set of machine-readable instructions to the client device 106 that cause the client device 106 to present the clothing size of the child, at operation 524. From the perspective of the requesting user, a request for a child's clothing size is submitted via a first GUI element, and in response, the child's clothing size is instantly displayed within a second GUI element.

FIG. 6 is a flow chart illustrating a method 600 for determining current body measurements of a child, according example embodiments. The method 600 may be embodied in computer-readable instructions for execution by one or more processors such that the steps of the method 600 may be performed in part or in whole by the application server 118. In particular, the method 600 may be carried out by the functional components of the child clothing size application 126, and accordingly, the method 600 is described below by way of example with reference thereto. However, it shall be appreciated that the method 600 may be deployed on various other hardware configurations such as the client device 106 and is not intended to be limited to the functional components of the child clothing size application 126.

At operation 605, the body measurement module 206 determines an age of the child at the time the image was captured. The body measurement module 206 may determine the age of the child at the time the image was captured based on obtained temporal attributes (e.g., received by a user or extracted from social data). For example, in some embodiments, the age of the child at the time the image was captured may be included as one of the obtained temporal attributes. In another example, the body measurement module 206 may determine the age of the child at the time the image was captured using the birth day of the child and the date on which the image was captured (e.g., provided by a timestamp included in the image data). In yet another example, the body measurement module 206 may determine the age of the child at the time the image was captured using the current age of the child and the date on which the image was captured (e.g., provided by a timestamp included in the image data).

At operation 610, the body measurement module 206 determines a current age of the child. The body measurement module 206 may determine the current age of the child based on obtained temporal attributes (e.g., received by a user or extracted from social data). For example, in some embodiments, the current age of the child may be included as one of the obtained temporal attributes. In another example, the body measurement module 206 may determine the current age of the child using the birth day of the child included as one of the obtained temporal attributes. In yet another example, the body measurement module 206 may determine the current age of the child using the age of the child at the time the image was captured and the date on which the image was captured (e.g., provided by a timestamp included in the image data).

At operation 615, the body measurement module 206 accesses expected growth data. The expected growth data may be accessed from the database 122 or from the third party server 108. The expected growth data includes expected body measurements for children at various ages along a certain timeline. The expected growth data may, for example, be developed from routinely conducted surveys of growing children.

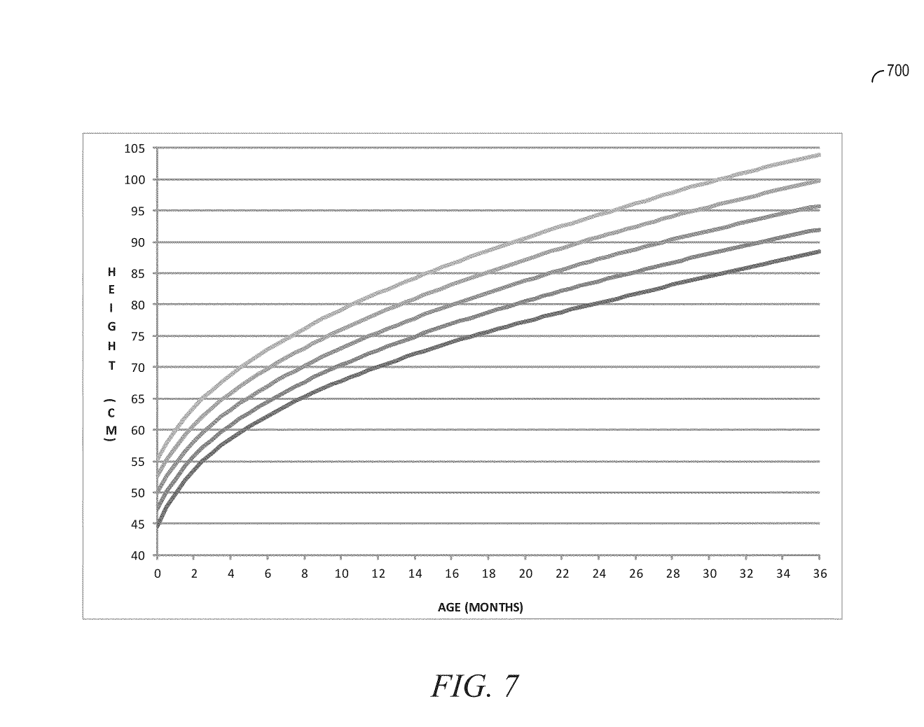

As an example, FIG. 7 is a chart illustrating expected growth data, according to an example embodiment. In particular, FIG. 7 illustrates a growth chart 700 comprising a series of percentile curves that illustrate the distribution of expected body measurements in children of varied initial body measurements over time. More specifically, FIG. 7 illustrates a series of percentile curves that track the height of children from ages 0-36 months.

Although the expected body measurements illustrated in FIG. 7 correspond to height of the child, the expected growth data is not limited to recumbent length and may, for example, include weight, body girth (e.g., waist size or chest size), head circumference, BMI, or stature. Further, although the growth chart 700 only illustrates expected body measurements up until the age of 36 months, the expected growth data is not limited in age to 36 months. Moreover, in some embodiments, the expected body measurements included in the expected growth data may depend on the sex of the child.

Returning to FIG. 6, at operation 620 the body measurement module 206 compares the previous body measurements of the child with the expected body measurements included in the expected growth data. At operation 625, the body measurement module 206 calculates one or more current body measurements of the child based on the comparison of the previous body measurements with the expected body measurements. For example, the body measurement module 206 may extrapolate the one or more current body measurements of the child from the expected growth data using the previous body measurements and the age of the child as of the previous body measurements. In some instances, the calculation of the one or more body measurements may include determining a percentile rank to which the child corresponds, and using the expected body measurements of the determined percentile rank to extrapolate the one or more current body measurements.

FIG. 8 is a flow chart illustrating a method 800 for identifying a child clothing size using a clothing size table, according to example embodiments. The method 800 may be embodied in computer-readable instructions for execution by one or more processors such that the steps of the method 800 may be performed in part or in whole by the application server 118. In particular, the method 800 may be carried out by the functional components of the child clothing size application 126, and accordingly, the method 800 is described below by way of example with reference thereto. However, it shall be appreciated that the method 800 may be deployed on various other hardware configurations such as the client device 106 and is not intended to be limited to the functional components of the child clothing size application 126.

At operation 805, the clothing size module 208 accesses clothing size data. The clothing size data may be accessed from a generic clothing size table or from a clothing size table provided by, or specific to, a particular clothing manufacturer or brand. Consistent with some embodiments, the particular clothing size data accessed may depend on the country in which the user requesting the child clothing size is located. The clothing size data includes a set of body measurements corresponding to each clothing size.

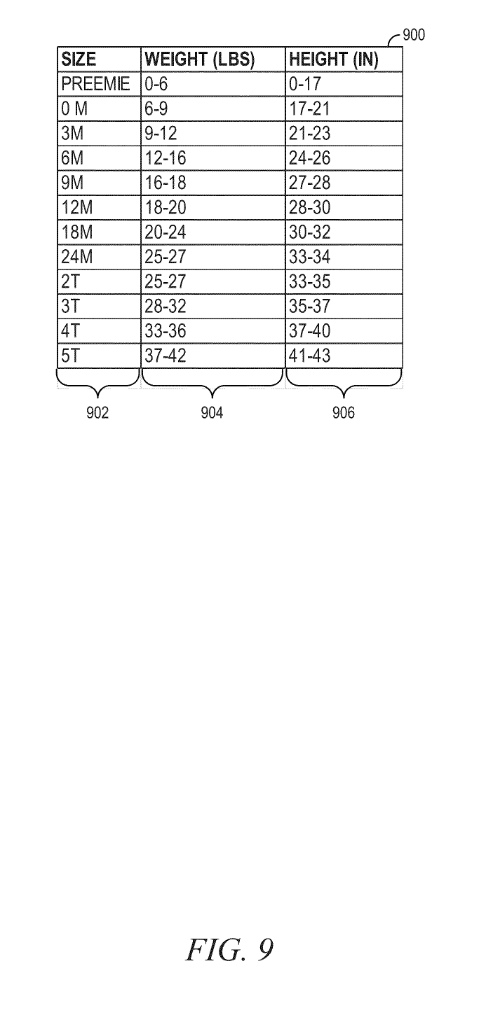

As an example, FIG. 9 illustrates a table 900 including clothing size data, according to an example embodiment. As shown, the table 900 comprises columns 902, 904, and 906. The column 902 includes a plurality of clothing sizes, and the columns 904 and 906 include a plurality of body measurement ranges—for weight and height (e.g., recumbent length), respectively—corresponding to each clothing size. It shall be appreciated that although the table 900 includes only weight and height measurements, the clothing size data may further include a head circumference, a chest size, a waist size, or any other such measurements that may be used to specify body proportions for the purpose of fitting clothes.

Returning to FIG. 8, at operation 810, the clothing size module 208 compares the current body measurements (e.g., determined by the body measurement module 206) of the child with the information in the clothing size data. At operation 815, the clothing size module 208 identifies the clothing size of the child based on the comparison with the clothing size data. Returning to FIG. 9 for the purpose of an illustrative example, if the height of the child is determined to be 22 inches, the clothing size module 208 identifies the clothing size of the child as 3 months.

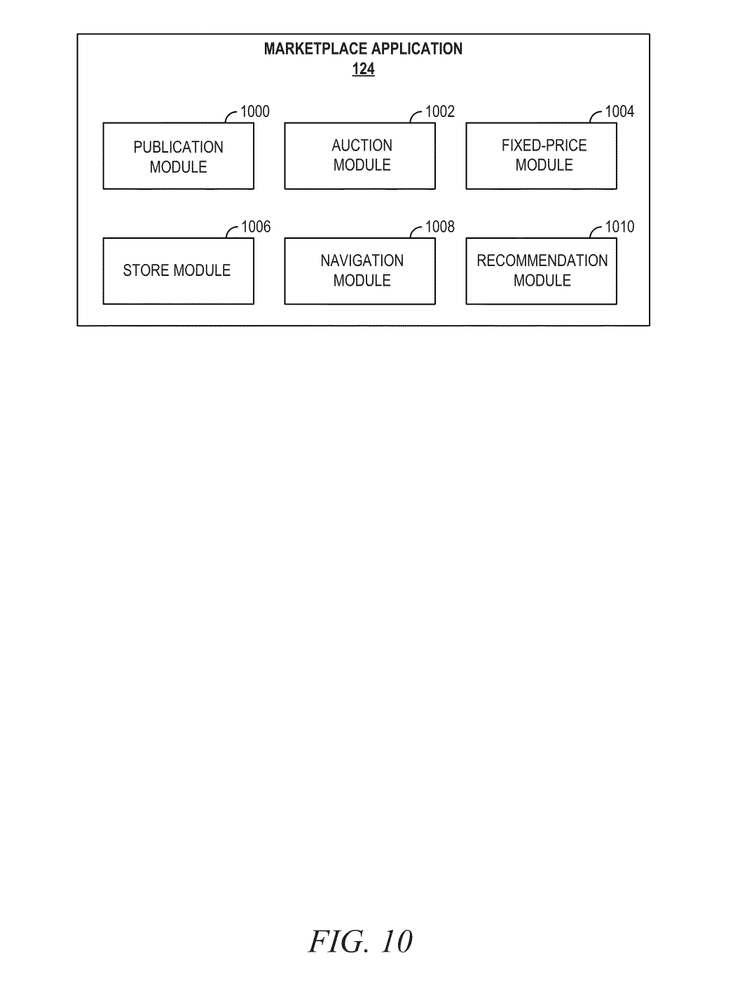

FIG. 10 is a block diagram illustrating various functional components of the marketplace application 124, which is provided by the network system 100, according to example embodiments. As is understood by skilled artisans in the relevant computer and Internet-related arts, each component (e.g., a module or engine) illustrated in FIG. 10 may represent a set of logic (e.g., executable software instructions) and the corresponding hardware (e.g., memory and processor) for executing the set of logic. Further, each component illustrated in FIG. 10 may be hosted on dedicated or shared server machines that are communicatively coupled to enable communications between server machines.

The marketplace application 124 is illustrated in FIG. 10 as including a publication module 1000, an auction module 1002, a fixed-price module 1004, a store module 1006, a navigation module 1008, and a recommendation module 1010, all configured to communicate with each other (e.g., via a bus, shared memory, a switch, or application programming interfaces (APIs)). Each of the various components of the marketplace application 124 may further access the database 122, and each of the various components of the marketplace application 124 may be in communication with one or more of the third party applications (e.g., third party application 128).

It will be appreciated that one or more the various components of the marketplace application 124 may be combined into a single component. Further, in some embodiments, one or more components may be omitted and additional components may also be included. Additionally, while the components depicted in FIG. 10 are discussed in the singular sense, it will be appreciated that in other embodiments multiple instances of any one of these components may be employed. Moreover, while the components depicted in FIG. 10 are shown to all form part of the marketplace application 124, it will be appreciated that, in alternative embodiments, any one of these components may form part of a service that is separate and distinct from the network-based content publisher 104.

The marketplace application 124 provides a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 124 is shown to include the publication module 1000 and the auction module 1002 which support auction-format listing and price setting mechanisms (e.g., English, Dutch, Vickrey, Chinese, Double, Reverse auctions etc.). The auction module 1002 may also provide a number of features in support of such auction-format listings, such as a reserve price feature whereby a seller may specify a reserve price in connection with a listing and a proxy-bidding feature whereby a bidder may invoke automated proxy bidding.

The fixed-price module 1004 supports fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

The store module 1006 allows sellers to group their item listings (e.g., goods and/or services) within a “virtual” store, which may be branded and otherwise personalized by and for the sellers. Such a virtual store may also offer promotions, incentives, and features that are specific and personalized to a relevant seller. In one embodiment, the listings and/or transactions associated with the virtual store and its features may be provided to one or more users.

Navigation of the content hosted by the network-based content publisher 104 may be facilitated by the navigation module 1008. For example, the navigation module 1008 enables keyword searches of listings published by the network-based content publisher 104 via the marketplace application 124. The navigation module 1008 may further allow users, via an associated user interface, to browse various category, catalogue, inventory, social network, and review data structures within the network-based content publisher 104. Various other navigation applications (e.g., an external search engine) may be provided by the navigation module 1008 to supplement the search and browsing functionality.

The recommendation module 1010 provides recommendation services and functions to users. The recommendations provided by the recommendation module 1010 include one or more items (e.g., products or services) that may potentially interest a user. In some embodiments, the recommendation module 1010 provides recommendations to users based on information contained in a corresponding user profile. For example, the recommendations provided by the recommendation module 1010 may be based on activity of the user such as previous products purchased by the user, a web page viewed by the user, or an item given favorable feedback by the user. In some embodiments, the recommendation module 1010 may generate recommendations for clothing items for a child based on a clothing size of the child determined by the child clothing size application 126. Such recommendations may be presented in conjunction with the determined clothing size of the child.

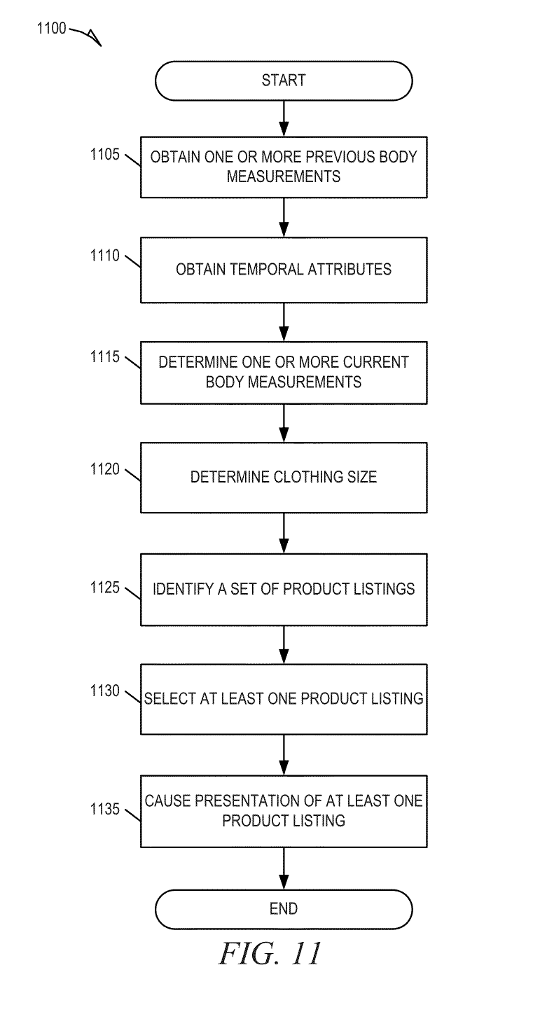

FIG. 11 is a flow chart illustrating a method 1100 for providing child clothing recommendations, according to example embodiments. The method 1100 may be embodied in computer-readable instructions for execution by one or more processors such that the steps of the method 1100 may be performed in part or in whole by the application server 118. In particular, the method 1100 may be carried out by the functional components of the child clothing size application 126, and accordingly, the method 1100 is described below by way of example with reference thereto. However, it shall be appreciated that the method 1100 may be deployed on various other hardware configurations such as the client device 106 and is not intended to be limited to the functional components of the child clothing size application 126.

At operation 1105, the body measurement module 206 obtains one or more previous body measurements of a child. At operation 1110, the body measurement module 206 obtains temporal attributes related to the age of the child. At operation 1115, the body measurement module 206 determines one or more current body measurements of the child. At operation 1120, the clothing size module 208 determines a current clothing size of the child using the one or more current body measurements of the child.

At operation 1125, the recommendation module 1010 identifies a set of product listings (e.g., published by the network-based content publisher 104) for children's clothing available in the current clothing size of the child. At operation 1130, the recommendation module 1010 selects at least one product listing from the set of product listings to provide as a recommendation. The at least one product listing selected may be based on the popularity of the product, current trends, or on user profile information (e.g., past purchase history, brand affinity, etc.). At operation 1135, the interface module 200 causes presentation of the at least one product listing (e.g., by providing the client device 106 with instructions that cause display of the product listings).

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field-programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Machine Architecture

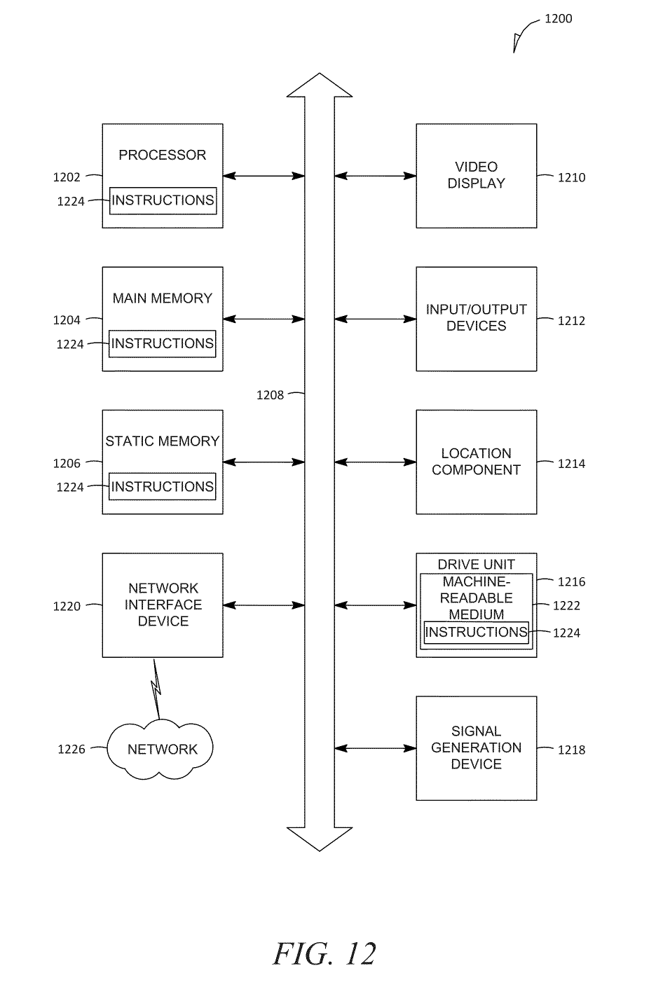

FIG. 12 is a diagrammatic representation of a machine in the example form of a computer system 1200 within which a set of instructions 1224 for causing the machine to perform any one or more of the methodologies discussed herein may be executed. The computer system 1200 may correspond to the client device 106, the third party server 108, the API server 114, the web server 116, or the application server 118, consistent with some embodiments. The computer system 1200 may include instructions 1224 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a personal digital assistant (PDA), a cellular telephone, a smart phone (e.g., iPhone®), a tablet computer, a web appliance, a handheld computer, a desktop computer, a laptop or netbook, a set-top box (STB) such as those provided by cable or satellite content providers, a wearable computing device such as glasses or a wristwatch, a multimedia device embedded in an automobile, a Global Positioning System (GPS) device, a data enabled book reader, a video game system console, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU), or both), a main memory 1204, and a static memory 1206, which communicate with each other via a bus 1208. The computer system 1200 may further include a video display 1210 (e.g., a liquid crystal display (LCD) or a cathode ray tube (CRT)). The computer system 1200 also includes one or more input/output (I/O) devices 1212, a location component 1214, a drive unit 1216, a signal generation device 1218 (e.g., a speaker), and a network interface device 1220. The I/O devices 1212 may, for example, include a keyboard, a mouse, a keypad, a multi-touch surface (e.g., a touchscreen or track pad), a microphone, a camera, and the like.

The location component 1214 may be used for determining a location of the computer system 1200. In some embodiments, the location component 1214 may correspond to a GPS transceiver that may make use of the network interface device 1220 to communicate GPS signals with a GPS satellite. The location component 1214 may also be configured to determine a location of the computer system 1200 by using an Internet Protocol (IP) address lookup or by triangulating a position based on nearby mobile communications towers. The location component 1214 may be further configured to store a user-defined location in the main memory 1204 or the static memory 1206. In some embodiments, a mobile location-enabled application may work in conjunction with the location component 1214 and the network interface device 1220 to transmit the location of the computer system 1200 to an application server or third party server for the purpose of identifying the location of a user operating the computer system 1200.

In some embodiments, the network interface device 1220 may correspond to a transceiver and antenna. The transceiver may be configured to both transmit and receive cellular network signals, wireless data signals, or other types of signals via the antenna, depending on the nature of the computer system 1200.

### Machine-Readable Medium

The drive unit 1216 includes a machine-readable medium 1222 on which is stored one or more sets of data structures and instructions 1224 (e.g., software) embodying or used by any one or more of the methodologies or functions described herein. The instructions 1224 may also reside, completely or at least partially, within the main memory 1204, the static memory 1206, and/or the processor 1202 during execution thereof by the computer system 1200, with the main memory 1204, the static memory 1206, and the processor 1202 also constituting machine-readable media.

Consistent with some embodiments, the instructions 1224 may relate to the operations of an operating system (OS). Depending on the particular type of the computer system 1200, the OS may, for example, be the iOS® operating system, the Android® operating system, a BlackBerry® operating system, the Microsoft® Windows® Phone operating system, Symbian® OS, or webOS®. Further, the instructions 1224 may relate to operations performed by applications (commonly known as “apps”), consistent with some embodiments. One example of such an application is a mobile browser application that displays content, such as a web page or a user interface using a browser.

While the machine-readable medium 1222 is shown in an example embodiment to be a single medium, the term “machine-readable medium” may include a single medium or multiple media (e.g., a centralized or distributed database, and/or associated caches and servers) that store the one or more data structures or instructions 1224. The term “machine-readable medium” shall also be taken to include any tangible medium that is capable of storing, encoding, or carrying instructions (e.g., the instructions 1224) for execution by the machine and that cause the machine to perform any one or more of the methodologies of the present disclosure, or that is capable of storing, encoding, or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

Furthermore, the tangible machine-readable medium is non-transitory in that it does not embody a propagating signal. However, labeling the tangible machine-readable medium “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 1224 may further be transmitted or received over a network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying the instructions 1224 for execution by the machine, and includes digital or analog communications signals or other intangible media to facilitate communication of such software.

Although the embodiments of the present inventive subject matter have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” and so forth are used merely as labels, and are not intended to impose numerical requirements on their objects.

What is claimed is:

1. A system comprising:
a processor-implemented retrieval module configured to obtain image data including an image depicting a child at a particular age;
a processor-implemented image analysis module configured to identify a reference object in the image, the reference object being of known dimensions, the image analysis module further configured to derive one or more previous body measurements of the child using the known dimensions of the reference object, the one or more previous body measurements corresponding to the child at the particular age;
a processor-implemented body measurement module configured to determine one or more current body measurements of the child based on the one or more previous body measurements of the child;
a processor-implemented clothing size module configured to determine a clothing size of the child based on the one or more current body measurements; and
a processor-implemented interface module configured to provide computer-readable instructions that cause presentation of the clothing size of the child.

2. The system of claim 1, wherein the processor-implemented interface module is further configured to receive a request for a child clothing size determination, wherein the request includes an identifier of a social network profile associated with the child, wherein the processor-implemented retrieval module obtains the image data by extracting the image data from social data corresponding to the social network profile.

3. The system of claim 1, wherein the processor-implemented body measurement module determines the one or more current body measurements using expected growth data.

4. The system of claim 1, wherein the processor-implemented body measurement module is configured to determine the one or more current body measurements by performing operations comprising;
determining the particular age of the child being depicted in the image;
determining a current age of the child;
accessing expected growth data, the expected growth data comprising a series of expected body measurements of children over time; and
extrapolating the one or more current body measurements of the child from the one or more previous body measurements using the particular age of the child, the current age of the child, and the expected body measurements.

5. The system of claim 4, wherein the processor-implemented body measurement module determines the particular age of the child based on a timestamp included in the image data.

6. The system of claim 4, wherein the processor-implemented body measurement module determines the current age of the child based on social data retrieved from a social network platform by the processor-implemented retrieval module.

7. The system of claim 1, wherein the processor-implemented clothing size module determines the clothing size of the child based on clothing size data comprising a mapping between a plurality of body measurements and a corresponding plurality of clothing sizes.

8. The system of claim 1, further comprising a processor-implemented recommendation module configured to identify one or more product listings for clothing available in the clothing size of the child, wherein the processor-implemented interface module is further configured to provide computer-readable instructions that cause presentation of the one or more product listings.

9. A method comprising:
obtaining image data including an image depicting a child at a particular age;
identifying a reference object in the image, the reference object being of known dimensions;
deriving, using the known dimensions of the reference object, one or more previous body measurements of the child at the particular age;
determining, using the one or more previous body measurements, one or more current body measurements of the child at a current age;
determining, by a hardware processor, a clothing size of the child based on the one or more current body measurements; and
providing computer-readable instructions that cause display of the clothing size.

10. The method of claim 9, further comprising receiving a request for a child clothing size determination, wherein the image data is included in the request.

11. The method of claim 9, further comprising:
receiving a request for a child clothing size determination, the request including an identifier of a social network profile associated with the child; and
retrieving social data corresponding to the social network profile, the social data including the image data.

12. The method of claim 9, wherein the determining of the one or more current body measurements of the child is based on expected growth data comprising a plurality of expected body measurements of children over time.

13. The method of claim 9, wherein the determining of the one or more current body measurements of the child comprises:
determining the particular age of the child being depicted in the image;
determining a current age of the child;
accessing expected growth data, the expected growth data comprising a series of expected body measurements of children over time; and
calculating the one or more current body measurements of the child based on a comparison of the one or more previous body measurements of the child at the particular age with the expected body measurements of children of the current age of the child.

14. The method of claim 13, wherein the particular age and the current age are determined based on social data corresponding to a social network profile associated with the child.

15. The method of claim 13, wherein the determining of the particular age of the child comprises:
determining an image capture date of the image based on a timestamp included in the image data; and
calculating the particular age of the child using the image capture date and a birth date of the child.

16. The method of claim 15, further comprising extracting the birth date from social data corresponding to a social network profile associated with the child.

17. The method of claim 9, wherein the determining of the clothing size of the child comprises:
accessing clothing size data comprising a mapping of a plurality of body measurements to a corresponding plurality of clothing sizes; and
identifying the clothing size of the child from the clothing size data using the one or more current body measurement of the child.

18. The method of claim 9, wherein the one or more previous body measurements include at least one of a height, a weight, a chest size, a waist size, or a head circumference.

19. The method of claim 9, further comprising:
identifying one or more product listings for clothing available in the clothing size of the child; and
providing computer-readable instructions that cause presentation of the one or more product listings.

20. A non-transitory machine-readable storage medium embodying instructions that, when executed by a machine, cause the machine to perform operations comprising:
obtaining image data including an image depicting a child at a particular age;
identifying a reference object in the image, the reference object being of known dimensions;
deriving, using the known dimensions of the reference object, one or more previous body measurements of the child at the particular age;
determining, using the one or more previous body measurements, one or more current body measurements of the child at a current age;
determining a clothing size of the child based on the one or more current body measurements; and
providing computer-readable instructions that cause presentation of the clothing size of the child.
